(19) United States
(12) Patent Application Publication
(10) Pub. No.: US 2002/0083117 A1
(43) Pub. Date: Jun. 27, 2002

(54) Assured quality-of-service request scheduling

(75) Inventor: Stephen M. Goddard, Lincoln, NE (US)

Correspondence Address: SENNIGER POWERS LEAVITT AND ROEDEL, ONE METROPOLITAN SQUARE, 16TH FLOOR, ST LOUIS, MO, 63102, US

(73) Assignee: The Board of Regents of the University of Nebraska

(21) Appl. No.: 10/008,024

(22) Filed: Nov. 5, 2001

Related U.S. Application Data
(60) Provisional application No. 60/245,788, filed on Nov. 3, 2000.
(60) Provisional application No. 60/245,789, filed on Nov. 3, 2000.
(60) Provisional application No. 60/245,790, filed on Nov. 3, 2000.
(60) Provisional application No. 60/245,859, filed on Nov. 3, 2000.

(51) Int. Cl. G06F 9/00

(52) U.S. Cl. 709/103

(57) ABSTRACT

A computer server and method for providing assured quality-of-service request scheduling in such a manner that low priority requests are not starved in the presence of higher priority requests. Each received data request is preferably assigned a priority having both a static priority component and a dynamic priority component. The static priority component is preferably determined according to a client priority, a requested resource priority, or both. The dynamic priority component is essentially an aging mechanism so that the priority of each request grows over time until serviced. Additionally, each assigned priority is preferably determined using a scaling factor which can be used to adjust a weighting of the static priority component relative to the dynamic priority component as necessary or desired for any specific application of the invention.

### REFERENCE TO RELATED APPLICATIONS

This application claims the benefit of U.S. Provisional Application No. 60,245,789 entitled ASSURED QOS REQUEST SCHEDULING, U.S. Provisional Application No. 60/245,788 entitled RATE-BASED RESOURCE ALLLOCATION (RBA) TECHNOLOGY, U.S. Provisional Application No. 60/245,790 entitled SASHA CLUSTER BASED WEB SERVER, and U.S. Provisional Application No. 60/245,859 entitled ACTIVE SET CONNECTION MANAGEMENT, all filed Nov. 3, 2000. The entire disclosures of the aforementioned applications are incorporated herein by reference.

### FIELD OF THE INVENTION

The present invention relates generally to computer servers, and more particularly to computer servers providing quality of service assurances.

### BACKGROUND OF THE INVENTION

The Internet Protocol (IP) provides what is called a “best effort” service; it makes no guarantees about when data will arrive, or how much data it can deliver. This limitation was initially not a problem for traditional computer network applications such as email, file transfers, and the like. But a new breed of applications, including audio and video streaming, not only demand high data throughput capacity, but also require low latency. Furthermore, as business is increasingly conducted over public and private IP networks, it becomes increasingly important for such networks to deliver appropriate levels of quality. Quality of Service (QoS) technologies have therefore been developed to provide quality, reliability and timeliness assurances.

Existing QoS implementations typically assign priorities to requests for data from a server on a client basis (i.e., data requests from different clients are prioritized differently), on a requested resource basis (i.e., data requests seeking different files or data are prioritized differently), or a combination of the two. One problem with such implementations is that low priority requests (i.e., requests from low priority clients and/or seeking low priority data) can become starved under heavy loading, with only higher priority requests being serviced.

As recognized by the inventor hereof, what is needed is a QoS approach which provides appropriate QoS assurances to high priority requests while, at the same time, ensuring that lower priority requests are serviced in a timely fashion and not starved.

### SUMMARY OF THE INVENTION

In order to solve these and other needs in the art, the inventor hereof has succeeded at designing a computer server and method for providing assured quality-of-service request scheduling in such a manner that low priority requests are not starved in the presence of higher priority requests. Each data request received from a client is preferably assigned a priority having both a static priority component and a dynamic priority component. The static priority component is preferably determined according to a client priority, a requested resource priority, or both. The dynamic priority is essentially an aging mechanism so that the priority of each request grows over time until serviced. Additionally, each assigned priority is preferably determined using a scaling factor which can be used to adjust a weighting of the static priority component relative to the dynamic priority component, as necessary or desired for any specific application of the invention.

In accordance with one aspect of the present invention, a computer server includes a dispatcher for receiving a plurality of data requests from clients, and for assigning a priority to each of the data requests. Each assigned priority includes a static priority component and a dynamic priority component. The computer server further includes at least one back-end server for processing data requests received from the dispatcher. The dispatcher is configured to forward the received data requests to the at least one back-end server in an order corresponding to their assigned priorities.

In accordance with another aspect of the present invention, a method of processing requests for data from a server includes receiving a plurality of data requests from clients, and assigning a priority to each of the data requests. Each assigned priority includes a static priority component and a dynamic priority component. The method also includes processing the received data requests as a function of their assigned priorities.

In accordance with still another aspect of the present invention, a method of processing requests for data from a server includes receiving a plurality of data requests and assigning a priority to each received data request. Each assigned priority includes a static priority component and a dynamic priority component. The method further includes storing the received data requests in a queue, retrieving the stored data requests from the queue in an order corresponding to their assigned priorities, and servicing the retrieved data requests.

In accordance with yet another aspect of the present invention, a method of processing requests for data from a server includes receiving a plurality of data requests, and, for each received data request, assigning a priority to the data request on a client basis, a requested resource basis, or both, and according to when the data request was received. The received data requests are then serviced in an order corresponding to their assigned priorities.

While some of the principal features and advantages of the invention have been described above, a greater and more thorough understanding of the invention may be attained by referring to the drawings and the detailed description of preferred embodiments which follow.

### BRIEF DESCRIPTION OF THE DRAWINGS

FIG. 1 is a block diagram of a server providing quality of service assurances according to one embodiment of the present invention.

FIG. 2 is a flow diagram of a method performed by the server of FIG. 1.

FIG. 3 is a block diagram of a server having multiple data request queues according to another preferred embodiment of the invention.

FIG. 4 is a block diagram of a cluster-based server providing quality of service assurances according to another preferred embodiment of the invention.

Corresponding reference characters indicate corresponding features throughout the several views of the drawings.

### DETAILED DESCRIPTION OF PREFERRED EMBODIMENTS

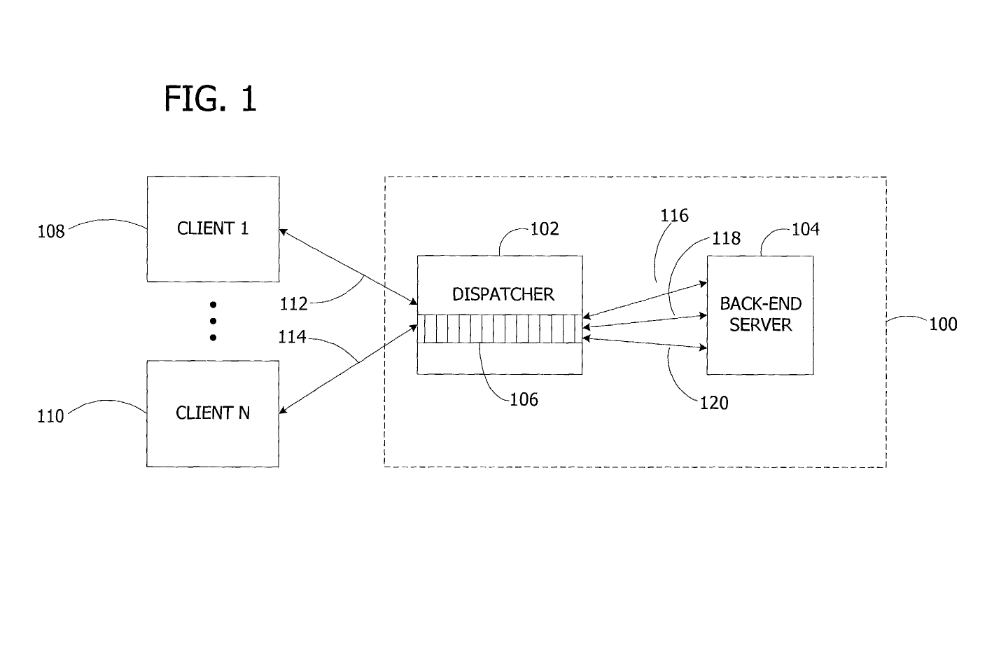

A computer server for providing assured quality of service request scheduling according to one preferred embodiment of the present invention is illustrated in FIG. 1 and indicated generally by reference character 100. As shown in FIG. 1, the server 100 includes a dispatcher 102 and a back-end server 104 (the phrase “back-end server” does not imply that the server 100 is a cluster-based server). In this particular embodiment, the dispatcher 102 is configured to support open systems integration (OSI) layer seven switching (also known as content-based routing) with layer three packet forwarding (L7/3), and includes a queue 106 for storing data requests (e.g., HTTP requests) received from exemplary clients 108, 110, as further explained below. Preferably, the dispatcher 102 is transparent to both the clients 108, 110 and the back-end server 104. That is, the clients perceive the dispatcher as a server, and the back-end server perceives the dispatcher as one or more clients.

The dispatcher 102 preferably maintains a front-end connection 112, 114 with each client 108, 110, and one or more back-end connections 116, 118, 120 with the back-end server 104. The back-end connections 116-120 are preferably non-client-specific, persistent connections, and the number of back-end connections maintained between the dispatcher 102 and the back-end server 104 is preferably dynamic such that it changes over time, as described in U.S. application Ser. No. 09/930,014 filed Aug. 15, 2001, the entire disclosure of which is incorporated herein by reference. Alternatively, non-persistent and/or client-specific back-end connections may be employed, and the number of back-end connections maintained between the dispatcher 102 and the back-end server 104 may be static. The front-end connections 112, 114 (as well as the back-end connections 116-120) may be established using HTTP/1.0, HTTP/1.1 or any other suitable protocol, and may or may not be persistent connections. The front-end connections 108, 110 and the back-end connections 116-120 may be established over any suitable public and/or private computer network(s), including local area networks (“LANs”) and wide area networks (“WANs”) such as the Internet.

While only two exemplary clients 108, 110 are shown in FIG. 1, it should be understood that a much larger number of clients may be supported by the server 100 without departing from the scope of the invention. Likewise, although FIG. 1 illustrates the dispatcher 102 as having three back-end connections 116-120 with the back-end server 104, it should be apparent from the description herein that the set of connections between the dispatcher 102 and the back-end server 104 may include more or less than three connections at any given time.

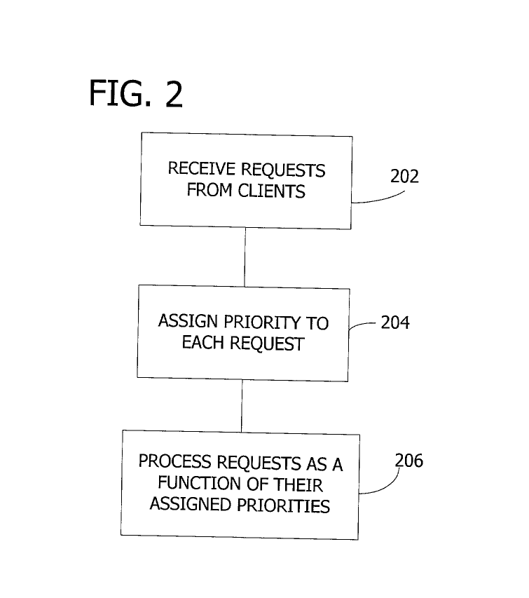

An overview of one preferred manner for implementing assured quality of service request scheduling within the server 100 will now be described with reference to the flow diagram of FIG. 2. Beginning at block 202, the server 100 receives multiple data requests from clients (e.g., over the exemplary front-end connections 112, 114 shown in FIG. 1). Via the dispatcher 102, the server 100 assigns a priority to each data request, as indicated in block 204 of FIG. 2. In the specific embodiment under discussion, a priority is assigned to each data request after the request is received by the server 100 from a client. The data requests are then processed as a function of their assigned priorities, as indicated in block 206 of FIG. 2.

Preferably, the data requests and their assigned priorities are initially stored in the queue 106 shown in FIG. 1, and are subsequently dequeued and forwarded to the back-end server 104 for processing as a function of their assigned priorities (i.e., in an order corresponding to their assigned priorities). The request with the highest priority is selected for processing first. The highest priority request may be defined as the request with either the maximum or the minimum priority value. As long as priorities are assigned based on the comparison function that will be used to select the next request for processing, the resulting schedule should be identical.

Referring again to block 204 of FIG. 2, each data request is preferably assigned a priority comprising a static component and a dynamic component. In one embodiment, this priority assignment is defined by the following Equation (1):

Pᵢ=Sᵢ+D₁ (1)

where Pᵢ is the priority assigned to request Rᵢ, Sᵢ is the static component and Dᵢ is the dynamic component. As further explained below, the static component is preferably used to prioritize the request based on the identity of the client which sent the request, and/or the specific resource sought by the request. The dynamic component is dynamic in the sense that it changes at least for each request received over a specific connection, and preferably for every request received by the server 100, regardless of connection, as further explained below. The dynamic component is essentially an aging mechanism which ensures that certain requests are not denied processing when the server 100 receives a relatively infinite sequence of requests having a higher static priority component. By changing the way Sᵢ and Dᵢ are calculated for request Rᵢ, a nearly infinite number of scheduling algorithms can be developed.

In one preferred embodiment, Sᵢ is computed using the following Equation (2):

Sᵢ=Kdᵢrᵢ (2)

where K is a scaling factor, dᵢ is a static priority of the client which sent the request (e.g., determined with reference to the client's IP address or subnet), and rᵢ is a static priority of the requested resource. An infinite number of priority assignment algorithms can be created using different values of K, dᵢ, and rᵢ. For example, assume dᵢ ranges from 0 to 1 depending on the priority assigned to a given domain name, K=100, and rᵢ ranges from 0 to 1 depending on the priority assigned to a given resource. Assuming the highest priority request is defined as max(Pᵢ) (i.e., the maximum priority value), the highest priority clients are assigned a dᵢ value of 1 and the lowest priority clients are assigned a dᵢ value of 0. Similarly, the highest priority resources are assigned a rᵢ value of 1 and the lowest priority resources are assigned a rᵢ value of 0. Under these assumptions, Sᵢ ranges from 0 to 100. The maximum value of Sᵢ is obtained only when a highest priority client requests a highest priority resource. Note that if the value of dᵢ is fixed, the static priority component is wholly dependent on rᵢ, and vice versa.

The dynamic priority component, Dᵢ, of Equation (1) is preferably computed using the following Equation (3) when max(Pᵢ) defines the highest priority request, or the following Equation (4) when min(Pᵢ) defines the highest priority request:

Dᵢ=Dₘₐₓ−1−(Rᵢ mod Dₘₐₓ) (3)

Dᵢ=(Rᵢ mod Dₘₐₓ) (4)

Using modulo arithmetic, Dᵢ ranges from 0 to Dₘₐₓ−1 in both Equations (3) and (4).

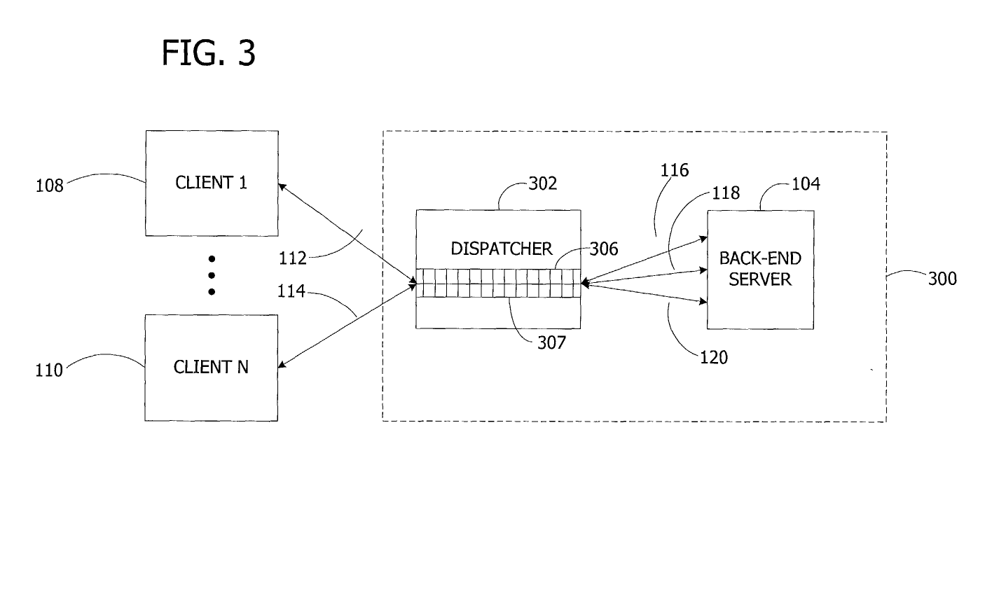

Assuming max(Pᵢ) defines the highest priority request and Dₘₐₓ=65536, the dynamic priority component for the first request, D₀, is 65535, the dynamic priority component for the second request, D₁, is 65534, and so on. Request Rₘₐₓ creates what is referred to as a wrap-around condition which may be dealt with in any suitable manner. In one alternative embodiment of the invention, shown in FIG. 3, a dispatcher 302 is provided with two data request queues 306, 307. The dispatcher 302 initially stores data requests received from clients in the first queue 306 until the wrap-around condition exists, and then stores subsequently received requests in the second queue 307. After all requests are retrieved from the first queue 306 and processed by the back-end server 104, the dispatcher 302 begins retrieving requests from the second queue 307 for processing. Note that under these conditions, if for some constant s, Sᵢ=s for all requests, a scheduling algorithm based on Equation (1) yields the same result as First-Come-First-Served (FCFS) scheduling.

Combining Equations (1), (2) and (3), the priority, Pᵢ, of each request, Rᵢ, can be computed using the following Equation (5) when max(Pᵢ) defines the highest priority request, or using the following Equation (6) when min(Pᵢ) defines the highest priority request:

Pᵢ=kdᵢrᵢ+Dₘₐₓ−1−(Rᵢ mod Dₘₐₓ) (5)

Pᵢ=kdᵢrᵢ+(Rᵢ mod Dₘₐₓ) (6)

From Equations (5) and (6), it should be clear that the scaling factor K can be used to adjust the weighting of the static priority component relative to the dynamic priority component in the overall priority Pᵢ.

As an example, suppose max(Pᵢ) defines the highest priority request, K=500, Dₘₐₓ=65536, and rᵢ and dᵢ are defined as follows:

| | | | Client |
|---|---|---|---|
| | | | Domain |
| | Resource | | Priority |
| Resource | Priority (rᵢ) | Client Domain | (dᵢ) |
| File1.html | 1.0 | 129.93.33.141 | 0.5 |
| File2.html | 0.1 | 192.168.11.114 | 1.0 |
| File3.html | 0.5 | 192.168.1.2 | 0.5 |

Suppose a 1^{st} request, R₀, is received from IP address “129.93.33.141” and seeks “file2.html.” Using Equation (5), this 1^{st} request is assigned a priority P₀=500 * (0.5*0.1)+65536−1− (0 mod 65536)=25+65536−1−0=65560. Suppose a 2^{nd} request, R₂, is received from IP address “192.168.11.114” and seeks “file1.html.” The 2^{nd} request is therefore assigned a priority P₁=500 * (1.0 * 1.0)+65536−1− (1 mod 65536)=500+65536−1−1=66034. Suppose further that a 500^{th} request, R₄₉₉, is received from IP address “192.168.1.2” seeking “file1.html.” The 500^{th} request is therefore assigned a priority P₄₉₉=500 * (0.5 * 1.0)+65536−1− (499 mod 65536)=250+65036=65285. Thus, if all three requests were pending in the queue 106 of FIG. 1 at the same time, they would be processed in the following order: R₁, R₀, R₄₉₉.

As apparent to those skilled in the art, the server 100 may receive one or more data requests from a particular client before the server 100 responds to a prior request from that client. (For example, the HTTP 1.1 protocol allows a client to send multiple requests over a single TCP/IP connection, even before responses to earlier requests are received by that client.) In one embodiment of the invention, this situation is addressed as follows. The first request received from the client is assigned a priority and then processed according to its assigned priority in the manner described above. When one or more additional requests are received from the client before the first request completes processing, the additional requests are simply stored in the queue 106 without being assigned a priority. Once the server 100 completes processing of the first request, the second request received from the client becomes eligible for processing. This second request can then be assigned a request number and corresponding priority, in the manner described above, as if the second request was just received by the server 100. Once the server 100 completes processing of the second request, the third request received from the client becomes eligible for processing, and so on.

Alternatively, data requests can be “aged” using a unique request counter R_{j,k} for each connection Cⱼ. When connection Cⱼ is established, the corresponding counter is initialized to 0 and incremented for each request received over that connection. Thus, for the k^{th} request of connection Cⱼ, R_{j,k}=k. The connection request number R_{j,k} is then used, rather than the general request counter Rᵢ, to set the priority of eligible requests. In such a case, the priority of each request can be computed using Equation (7) when max(Pᵢ) defines the highest priority request, or using the following Equation (8) when min(Pᵢ) defines the highest priority request:

Pᵢ=Kdᵢrᵢ+Dₘₐₓ−1−(R_{j,k} mod Dₘₐₓ) (7)

Pᵢ=Kdᵢrᵢ+(R_{j,k} mod Dₘₐₓ) (8)

Note that use of R_{j,k} rather than Rᵢ in computing a request's priority changes the notion of fairness. When Equation (7) or (8) is used to compute priorities, the first request of every connection has its dynamic priority component set to its maximum value. Thus, given a set of connections with requests of equal static priority components, the request from the connection with the fewest processed requests will be given higher priority over requests from the other connections. When Equation (7) or Equation (8) is used with the HTTP 1.0 protocol, in which connections can make at most only one request, the dynamic priority component, Dᵢ, of Equation (1) is always zero such that the scheduling algorithm reduces to simple static priority scheduling.

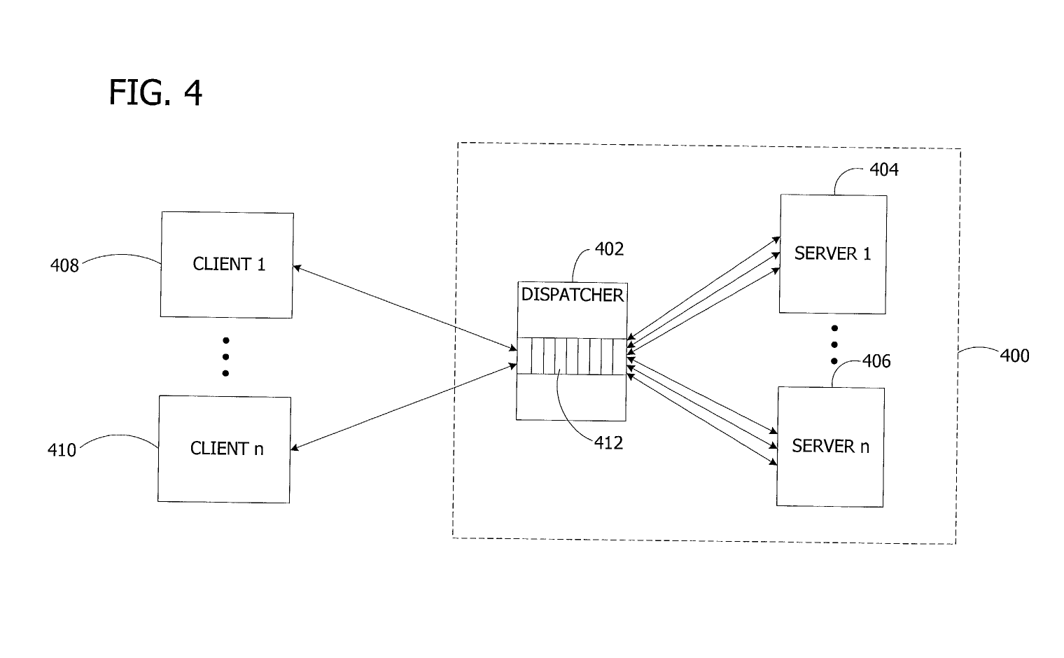

A cluster-based server 400 according to another preferred embodiment of the present invention is shown in FIG. 4, and is preferably implemented in a manner similar to the embodiment described above with reference to FIG. 1. As shown in FIG. 4, the cluster-based server 400 employs multiple back-end servers 404, 406 for processing data requests provided by exemplary clients 408, 410 through an L7 dispatcher 402 having at least one queue 412. The dispatcher 402 preferably receives data requests from clients and assigns priorities thereto before storing the data requests and their assigned priorities in the queue 412. Each time one of the back-end servers 404, 406 becomes available for processing another data request, the dispatcher 402 retrieves one of the data requests from the queue 412 in accordance with the assigned priorities, and forwards the retrieved data request to the available back-end server for processing. As should be apparent, by providing the server 400 with two or more back-end servers 404, 406 in a clustered arrangement, the processing ability of the server 400 is markedly increased.

The dispatchers 102, 302 402 shown in FIGS. 1, 2 and 4, respectively, as well as the back-end servers, are preferably implemented entirely in application-space, as described in U.S. application Ser. No. 09/878,787 filed Jun. 11, 2001, the entire disclosure of which is incorporated herein by reference. As such, the dispatchers and back-end servers may be implemented using commercially-off-the-shelf (COTS) hardware and COTS operating system software. This is in contrast to using custom hardware and/or OS software, which is typically more expensive and less flexible.

In one alternative embodiment of the invention, it is connection requests, rather than data requests, that are prioritized and queued by a server having a dispatcher implementing OSI layer four switching with layer three packet forwarding (“L4/3”). In this alternative embodiment, connection requests received from clients are assigned priorities in a manner similar to that described above: each priority includes a static component, based solely on the client priority (the static component cannot also be a function of the requested resource unless the dispatcher is configured to inspect the contents of the data requests, which is generally not done in L4/3 dispatching), and a dynamic component based on when the connection request was received relative to other connection requests. Thus, once a connection request is dequeued and forwarded to a back-end server for service, the back-end server establishes a connection with the corresponding client, and will continue to service data requests from that client (while other connection requests are stored by the dispatcher in a queue) until the connection is terminated. The server of this alternative embodiment is preferably a cluster-based server, and is preferably implemented in a manner described in U.S. application Ser. No. 09/965,526 filed Sep. 26, 2001, the entire disclosure of which is incorporated herein by reference. The dispatchers and back-end servers described herein may each be implemented as a distinct device, or may together be implemented in a single computer device having one or more processors.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed:

1. A computer server comprising:
a dispatcher for receiving a plurality of data requests from clients, and for assigning a priority to each of the data requests, each assigned priority including a static priority component and a dynamic priority component; and
at least one back-end server for processing data requests received from the dispatcher;
wherein the dispatcher is configured to forward the received data requests to the at least one back-end server in an order corresponding to their assigned priorities including their static priority components and their dynamic priority components.

2. The computer server of claim 1 wherein the dispatcher includes at least one queue for storing the received data requests, and wherein the dispatcher is configured for retrieving data requests from the queue in an order corresponding to their assigned priorities.

3. The computer server of claim 2 wherein the at least one queue includes a first queue and a second queue, and wherein the dispatcher is configured to store received data requests in the first queue until a wrap-around condition exists for the assigned priorities, and to then store received data requests in the second queue.

4. The computer server of claim 3 wherein the dispatcher is configured to retrieve data requests from the first queue prior to retrieving data requests from the second queue.

5. The computer server of claim 1 wherein the at least one back-end server comprises at least two back-end servers for processing data requests received from the dispatcher, and wherein the computer server is a cluster-based server.

6. The computer server of claim 1 wherein the dispatcher is an L7/3 dispatcher.

7. The computer server of claim 6 wherein the dispatcher is implemented entirely in application-space using COTS hardware and COTS OS software.

8. The computer server of claim 1 wherein each assigned priority is determined from an equation Pᵢ=Sᵢ+Dᵢ, where Pᵢ is the assigned priority of data request Rᵢ, Sᵢ is the static priority component for data request Rᵢ, and Dᵢ is the dynamic priority component for data request Rᵢ.

9. The computer server of claim 8 wherein each dynamic priority component is determined from an equation
Dᵢ=Dₘₐₓ−1−(R₁ mod Dₘₐₓ),
where max(Pᵢ) defines a highest priority data request.

10. The computer server of claim 8 wherein each dynamic priority component is determined from an equation
Dᵢ=(Rᵢ mod Dₘₐₓ),
where min(Pᵢ) defines a highest priority data request.

11. A method of processing requests for data from a server, the method comprising:
receiving a plurality of data requests from clients;
assigning a priority to each of the data requests, each assigned priority including a static priority component and a dynamic priority component; and
processing the received data requests as a function of their assigned priorities including their static priority components and their dynamic priority components.

12. The method of claim 11 further comprising storing the received data requests and their assigned priorities in one or more queues, and wherein the processing includes retrieving the stored data requests from said one or more queues and forwarding the retrieved data requests to one or more back-end servers for service.

13. The method of claim 11 wherein the assigning includes determining the dynamic priority component for each data request received over a specific connection as a function of when that data request is received relative to other data requests received over said specific connection or another connection.

14. The method of claim 11 wherein the assigning includes determining the dynamic priority component for each data request received over a specific connection solely as a function of when that data request is received relative to other data requests received over said specific connection.

15. The method of claim 11 wherein the receiving includes receiving a plurality of data requests over a same connection, and wherein the assigning includes assigning a priority to a first one of the data requests received over the same connection, and assigning a priority to a second one of the data requests received over the same connection only after said first one of the data requests undergoes the processing.

16. The method of claim 11 wherein each static priority component is represented by a number, wherein each dynamic priority component is represented by a number, and wherein each assigned priority is determined by summing its static priority component and its dynamic priority component.

17. The method of claim 11 wherein the assigning includes determining the static priority component on a client basis, a requested resource basis, or both.

18. The method of claim 11 wherein the assigning is performed after the receiving.

19. A computer-readable medium having computer-executable instructions for performing the method of claim 11.

20. A method of processing requests for data from a server, the method comprising:
receiving a plurality of data requests;
assigning a priority to each received data request, each assigned priority including a static priority component and a dynamic priority component;
storing the received data requests in a queue;
retrieving the stored data requests from the queue in an order corresponding to their assigned priorities including their static priority components and their dynamic priority components; and
servicing the retrieved data requests.

21. The method of claim 20 wherein the assigning includes determining the dynamic priority component for each received data request according to when that data request is received with respect to other data requests.

22. The method of claim 20 wherein the storing includes storing the received data requests and their assigned priorities in the queue.

23. The method of claim 20 wherein the dynamic priority component is determined using a general request counter.

24. The method of claim 20 wherein the dynamic priority component is determined using a connection request counter.

25. A method of processing requests for data from a server, the method comprising:
receiving a plurality of data requests;
for each received data request, assigning a priority to the data request on a client basis, a requested resource basis, or both, and according to when the data request was received; and
servicing the received data requests in an order corresponding to their assigned priorities.

26. The method of claim 25 wherein the receiving step includes receiving the plurality of data requests at a dispatcher, the assigning step includes assigning at the dispatcher a priority to each received data request, and the servicing step includes servicing the received data requests using at least one back-end server.
